(19) United States
(12) Patent Application Publication
(10) Pub. No.: US 2021/0306230 A1
(43) Pub. Date: Sep. 30, 2021

(54) COMMUNICATION SYSTEM AND COMMUNICATION METHOD

(71) Applicant: NIPPON TELEGRAPH AND TELEPHONE CORPORATION, Tokyo (JP)

(72) Inventors: Shinya ARITA, Tokyo (JP); Toru OKUGAWA, Tokyo (JP); Hidetaka NISHIHARA, Tokyo (JP); Aki FUKUOKA, Tokyo (JP)

(73) Assignee: NIPPON TELEGRAPH AND TELEPHONE CORPORATION, Tokyo (JP)

(21) Appl. No.: 17/266,265

(22) PCT Filed: Aug. 7, 2019
(86) PCT No.: PCT/JP2019/031263

§ 371 Date: Feb. 5, 2021

(30) Foreign Application Priority Data
Aug. 9, 2018 (JP) 2018-150909

(51) Int. Cl. H04L 12/24

(52) U.S. Cl. CPC H04L 41/5009; H04L 41/5054; H04L 41/5025

(57) ABSTRACT

In a communication system (100), a collector (80) measures the usage condition in a service accommodated in a pre-generated default slice (20). Then, depending on the measured usage condition, the dispatching unit (40) dispatches the service accommodated in the default slice (20) to be accommodated in another new slice (30) separate from the default slice (20).

### TECHNICAL FIELD

The present invention relates to a communication system and a communication method.

### BACKGROUND ART

To provide network services flexibly and quickly to a wide variety of service requirements, according to a related-art network slice technology, a virtual network (hereinafter referred to as slice as appropriate) is constructed on a common network infrastructure according to service-to-service requirements, thereby efficiently satisfying high-level requirements required for the service.

There is a demand that the slice can be generated, changed, and deleted on demand as a logical network superimposed on a common physical resource. As specific techniques, virtualization of the network infrastructure using the Software Defined Network (SDN) technology, and virtualization of network functions using the Network Function Virtualization (NFV) technology are contemplated.

In such network slice technology, the service operator complies with service requirements to order the required slice from the network slice catalog, procure the required resource from the virtual resource of the infrastructure operator, and construct the slice.

### CITATION LIST

### Non Patent Literature

Non Patent Literature 1: “Toward Future Mobile Network Realization”, [online], NTT DOCOMO, INC. [Searched on Aug. 1, 2018], Internet <http://www.soumu.go.jp/main_content/000461464.pdf>
Non Patent Document 2: Shinya Arita, Hideomi Nishihara, Tohru Okugawa, “Examination of Telemetry Method for Network Slice”, IEICE Technical Report vol. 118, no. 6, NS2018-3, pp. 13-17, April 2018

### SUMMARY OF THE INVENTION

### Technical Problem

However, related-art technology has a problem that the resource for the slice may not be efficiently used. For example, according to the related-art technology, because the resource is previously reserved based on the order of the service operator to provide the slice, when there is discrepancy between the reserved resource and the actual usage condition, the resource cannot be efficiently used.

### Means for Solving the Problem

In order to solve the aforementioned problem and achieve an object, a communication system of the present invention includes: a measurement unit configured to measure a usage condition in a service accommodated in a pre-generated default slice; and a dispatching unit configured to dispatch the service accommodated in the default slice to be accommodated in another slice separate from the default slice according to the usage condition measured by the measurement unit.

In addition, a communication method of the present invention is a communication method performed by a communication system, and the method includes: measuring a usage condition in a service accommodated in a pre-generated default slice; and dispatching the service accommodated in the default slice to be accommodated in another slice separate from the default slice according to the usage condition measured through the measuring.

### Effects of the Invention

The present invention achieves the effect of improving the resource usage efficiency for the slice.

### BRIEF DESCRIPTION OF DRAWINGS

FIG. 1 is a diagram illustrating one example of the configuration of a communication system according to the first embodiment.

FIG. 2 is a diagram illustrating the operating procedure in the communication system according to the first embodiment.

FIG. 3 is a diagram illustrating the operating procedure in the communication system according to the first embodiment.

FIG. 4 is a diagram illustrating the operating procedure in the communication system according to the first embodiment.

FIG. 5 is a diagram illustrating an overview of processing of the communication system according to the first embodiment.

FIG. 6 is a sequence diagram illustrating an example of processing of the communication system according to the first embodiment.

FIG. 7 is a diagram for describing a related-art problem.

FIG. 8 is a diagram for describing the related-art problem.

FIG. 9 is a diagram illustrating a computer that executes a program.

### DESCRIPTION OF EMBODIMENTS

An embodiment of a communication system and a communication method according to the present application will be described below in detail based on the drawings. Note that the communication system and the communication method according to the present application are not limited to the embodiment.

### First Embodiment

In the following embodiment, the configuration of the communication system according to the first embodiment and the processing flow in the communication system will be described sequentially, and finally, the effects according to the first embodiment will be described.

Configuration of Communication System

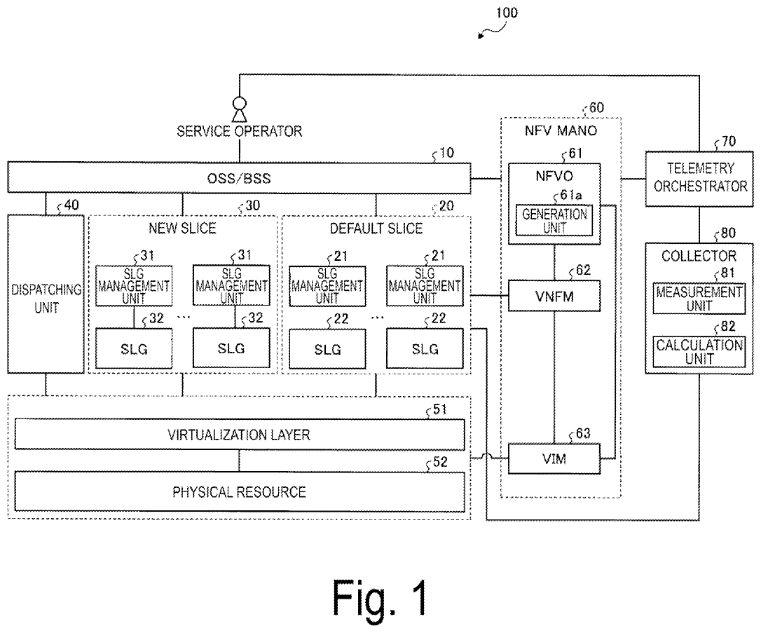

First, with reference to FIG. 1, a communication system 100 according to the first embodiment will be described. FIG. 1 is a diagram illustrating one example of the configuration of a communication system according to the first embodiment. The communication system 100 according to the first embodiment virtually constructs network slices on a common network infrastructure according to service-by-service requirements to efficiently achieve high levels of request conditions required for the service.

For example, as illustrated in FIG. 1, the communication system 100 includes: an Operation Support System (OSS)/Business Support System (BSS) 10; a default slice 20 and a new slice 30 that are built on a common physical resource 52 and a virtualization layer 51, a dispatching unit 40, an NFV management and network orchestration (NFV MANO) 60, a telemetry orchestrator 70, and a collector 80. Note that the functional components may use the same physical resource or separate physical resources.

The OSS/BSS 10 is a system for an operator (carrier) providing communication services to construct and operate the services.

The default slice 20 is a best-effort network slice accommodating the services. The default slice 20 includes a plurality of Slice Gateway (SLG) management units 21 and a plurality of SLGs 22 corresponding to the SLG management units 21. Here, each SLG 22 acts as a Virtual Network Function (VNF), and has telemetry function.

The new slice 30 is a network slice accommodating services that have failed to meet service requirements in the default slice 20. The new slice 30 includes a plurality of SLG management units 31 and a plurality of SLGs 32 corresponding to the SLG management units 31.

Depending on the usage condition measured by the collector 80, the dispatching unit 40 dispatches the service accommodated in the default slice to be accommodated in another new slice separate from the default slice. For example, the dispatching unit 40 may switch only the sub-slice that has failed to meet service requirements to another sub-slice. For example, the dispatching unit 40 switches the sub-slice determined to be unable to meet predetermined service requirements to another sub-slice, based on the usage condition measured by the collector 80.

The NFV MANO 60 includes a Network Functions Virtualization Orchestrator (NFVO) 61, a Virtual Network Function Manager (VNFM) 62, and a Virtual Infrastructure Management (VIM) 63. Life cycle management, such as instance generation, deletion, scale out, and the like of each VNF including SLGs 22, 32, is controlled by the VNFM 62. Furthermore, the virtualization layer 51 and the physical resource 52, which are NFV infrastructures (NFVI), are controlled by the VIM.

The NFVO 61 includes a generation unit 61a as one function unit. The generation unit 61a generates the new slice based on the usage condition measured by the collector. For example, the generation unit 61a instructs generation of a new sub-slice for the sub-slice that has failed to meet the service requirements, based on the required resource amount calculated by the collector 80.

The telemetry orchestrator 70 acquires information such as the slice service requirements, slice setting contents, and telemetry setting contents from the OSS/BSS 10. In addition, for the services accommodated in the default slice 20, the telemetry orchestrator 70 receives the required resource amount based on the service usage condition in the default slice 20 from the collector 80. Then, the telemetry orchestrator 70 identifies the service that has failed to meet the service requirements in the default slice 20, and proposes the generation of the new slice 30 that newly accommodate the identified service to the OSS/BSS 10.

For the services accommodated in the default slice 20, the collector 80 measures the usage condition in slice units from SLG 22 and calculates the required resource amount based on the service usage condition in the default slice 20. The collector 80 includes a measurement unit 81 and a calculation unit 82.

The measurement unit 81 measures the usage condition in the service accommodated in the pre-generated default slice 20. Specifically, the measurement unit 81 measures the usage condition in sub-slice units in the default slice 20. For example, the measurement unit 81 acquires, as a usage condition, traffic amount, CPU utilization, delay time, and the like from each SLG 22 of the default slice 20.

Based on the usage condition measured by the measurement unit 81, the calculation unit 82 calculates the required resource amount for the service accommodated in the default slice 20. Then, the calculation unit 82 notifies the calculated required resource amount to the telemetry orchestrator 70.

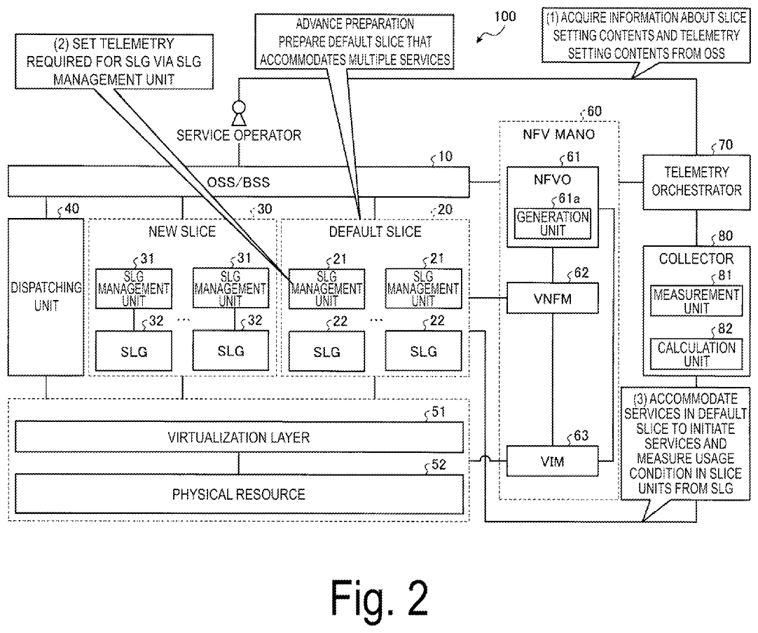

A series of operations in the communication system 100 according to the first embodiment will be described with reference to FIGS. 2 to 4. FIGS. 2 to 4 are diagrams illustrating an operating procedure in the communication system according to the first embodiment. As illustrated in FIG. 2, in the communication system 100, a default slice accommodating a plurality of services is prepared in advance. Next, the telemetry orchestrator 70 acquires information about the slice setting contents and the telemetry setting contents from the OSS/BSS 10 (see FIG. 2(1)). Next, the OSS/BSS 10 sets the telemetry required for the SLGs 22 via the SLG management units 21 of the default slice 20 (see FIG. 2(2)).

Then, the communication system 100 accommodates the services in the default slice 20 to initiate the services. Then, for services accommodated in the default slice 20, the collector 80 measures the usage condition in slice units from the SLGs 22 (see FIG. 2(3)).

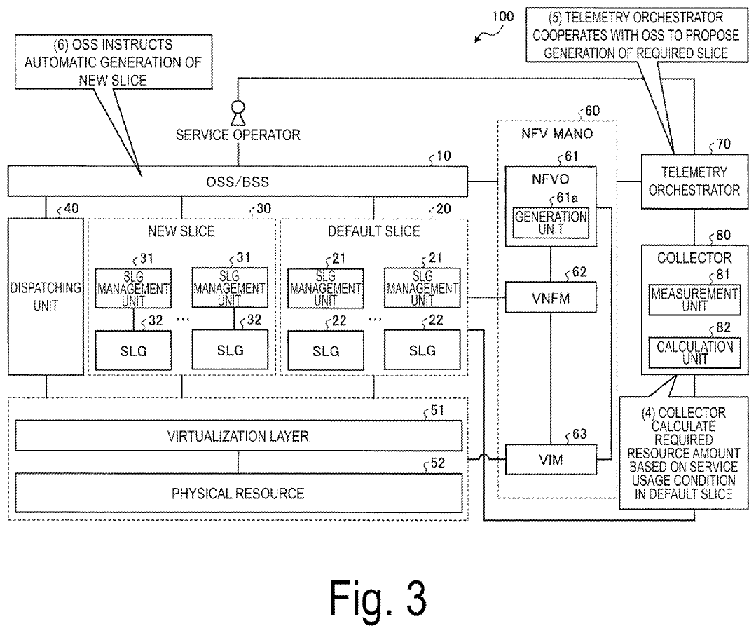

Subsequently, as illustrated in FIG. 3, the collector 80 calculates the required resource amount based on the service usage condition in the default slice 20 (see FIG. 3(4)). Then, for the services accommodated in the default slice 20, the telemetry orchestrator 70 receives the required resource amount based on the service usage condition in the default slice 20 from the collector 80.

Then, the telemetry orchestrator 70 identifies the service that has failed to meet the service requirements in the default slice 20, and proposes the generation of the new slice that newly accommodate the identified service to the OSS/BSS 10 (see FIG. 3(5)). At this time, the telemetry orchestrator 70 may notify the resource amount required to meet the service requirements of the service to the OSS/BSS 10.

Then, the OSS/BSS 10 instructs the NFVO 61 to automatically generate the new slice 30 (see FIG. 3(6)). For example, the OSS/BSS 10 notifies the required resource amount received from the telemetry orchestrator 70 to the NFVO 61, as well as instructs the NFVO 61 to automatically generate the new slice 30. Then, the NFVO 61 procures the required resource based on the required resource amount, and automatically generates a new sub-slice.

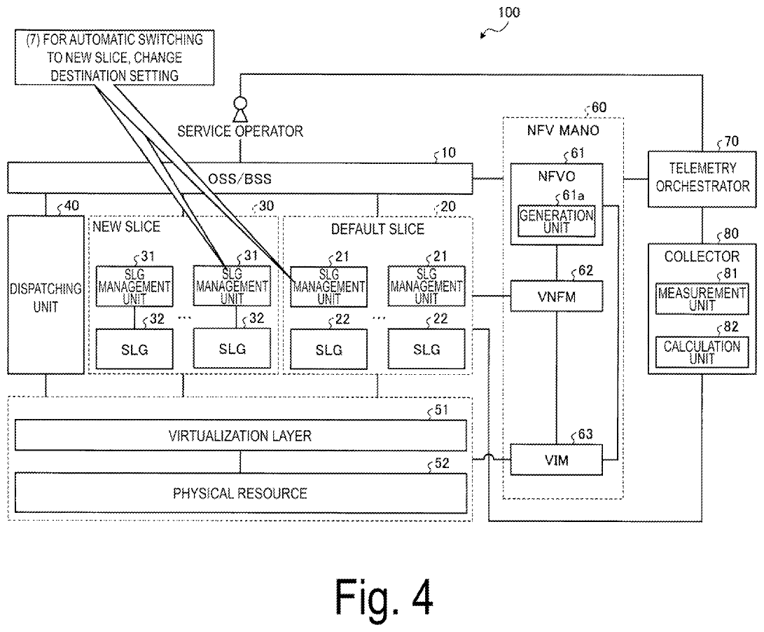

Thereafter, as illustrated in FIG. 4, in the communication system 100, a destination setting change instruction is issued from the OSS/BSS 10 to the dispatching unit 40, such that the dispatching unit 40 switches the service to the new slice 30 (see FIG. 4(7)). For example, the dispatching unit 40 may switch only the sub-slice that has failed to meet the service requirements to another sub-slice. Note that as in the switched new slice, resource change or slice switching may be performed based on the usage condition in slice units to optimize slice design. Note that a slice to be switched may be prepared in advance to be switched without generating new slices each time.

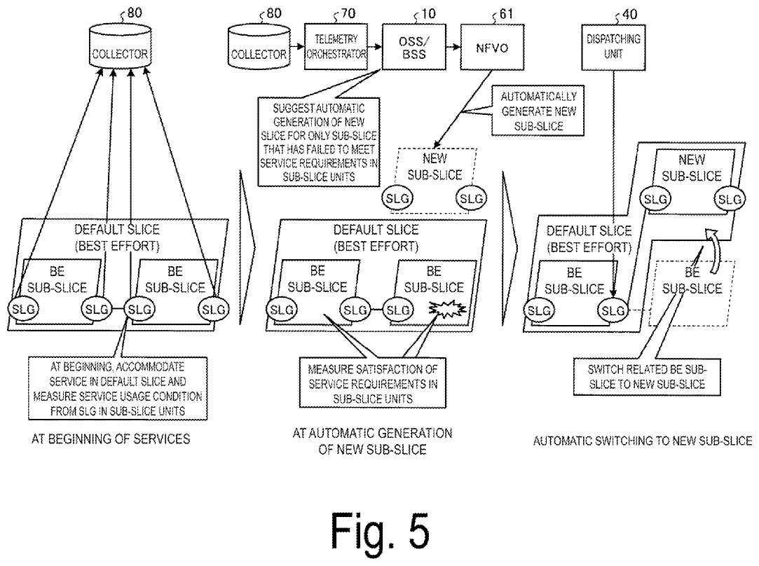

Here, with reference to FIG. 5, the processing flow in the communication system 100 in which the services are accommodated in the default slice at start of the services, and only the sub-slice that has failed to meet the service requirements (described as BE (best effort) sub-slice in FIG. 5) is switched to another sub-slice will be described. FIG. 5 is a diagram illustrating an overview of the processing in the communication system according to the first embodiment.

As illustrated in FIG. 5, in the communication system 100, at beginning of the services, the services are accommodated in the default slice. Then, the collector 80 measures the service usage condition in sub-slice units from the SLG. Thereafter, the telemetry orchestrator 70 proposes the OSS/BSS 10 to automatically generate the new slice only for the sub-slice that has failed to meet the service requirements in sub-slice units.

Then, the NFVO 61 automatically generates the new sub-slice. That is, the NFVO 61 procures resource required to meet the service requirements and automatically generates the new sub-slice. Thereafter, the dispatching unit 40 switches the relevant sub-slice from the default sub-slice to the new sub-slice.

Processing Flow of Communication System

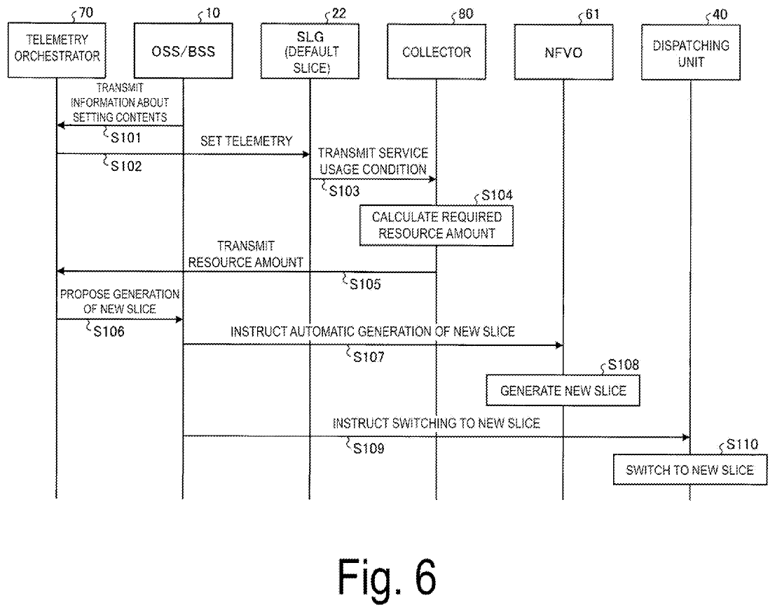

Next, the processing flow of processing of the communication system 100 according to the first embodiment will be described with reference to FIG. 6. FIG. 6 is a sequence diagram illustrating an example of the processing of the communication system according to the first embodiment.

As illustrated in FIG. 6, the telemetry orchestrator 70 acquires information about the slice setting contents and the telemetry setting contents, which is transmitted from the OSS/BSS 10 (step S101). Next, the telemetry orchestrator 70 sets the telemetry required for the SLGs 22 via the OSS/BSS 10 (step S102). For example, the telemetry orchestrator 70 notifies parameters related to the telemetry to the OSS/BSS 10, and sets the telemetry required for the SLGs 22 based on the parameters.

Then, the SLGs 22 periodically transmits the usage condition of the services to the collector 80 (step S103). The collector 80 calculates the required resource amount based on the service usage condition in the default slice 20 (step S104). Then, the collector 80 transmits the calculated required resource amount to the telemetry orchestrator 70 (step S105).

Subsequently, the telemetry orchestrator 70 identifies the service that has failed to meet the service requirements in the default slice 20, and proposes the generation of the new slice that newly accommodate the identified service to the OSS/BSS 10 (step S106).

Then, the OSS/BSS 10 instructs the NFVO 61 to automatically generate the new slice 30 (step S107). For example, the OSS/BSS 10 notifies the required resource amount received from the telemetry orchestrator 70 to the NFVO 61, as well as instructs the NFVO 61 to automatically generate the new slice 30. Then, based on the required resource amount, the NFVO 61 procures the required resource to automatically generate a new sub-slice (step S108).

Thereafter, the OSS/BSS 10 instructs the dispatching unit 40 to switch the service to the new slice (step S109). Then, the dispatching unit 40 performs processing of switching the accommodation destination of the service accommodated in the default slice 20 from the default slice 20 to the new slice 30 (step S110).

### Effects of First Embodiment

As such, in the communication system 100 according to the first embodiment, the collector 80 measures the usage condition in the services accommodated in the pre-generated default slice 20. Then, according to the measured usage condition, the dispatching unit 40 dispatches the services accommodated in the default slice 20 to be accommodated in another new slice 30 separate from the default slice 20. Thus, the communication system 100 according to the first embodiment can improve the resource usage efficiency for the slice.

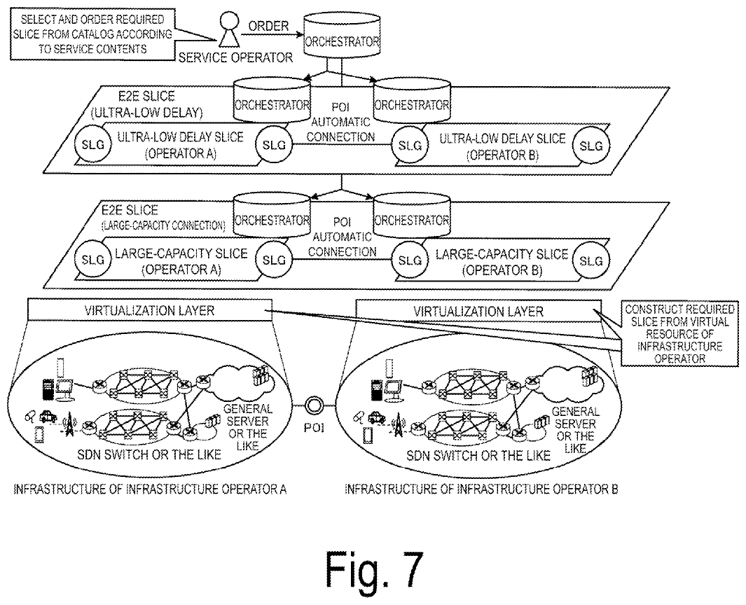

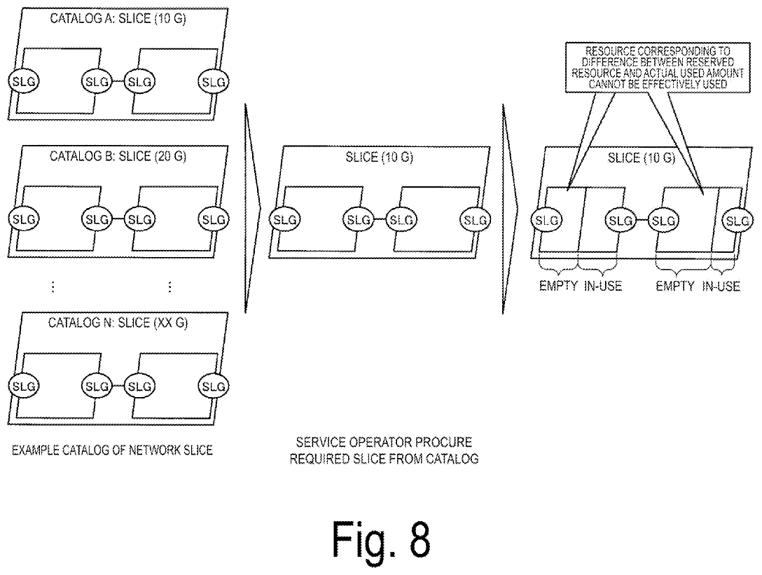

That is, heretofore, as illustrated in FIG. 7, the service operator selects and orders the slice required for service contents from the catalog, thereby procuring required resource from the virtual resource of the infrastructure operator to construct the slice. Thus, as illustrated in FIG. 8, according to the related-art technology, the resource is previously reserved based on the order of the service operator to provide the slice. However, when there is discrepancy between the reserved resource and actual usage condition, the resource corresponding to the difference between the reserved resource and the actual used amount cannot be effectively used.

In contrast, in communication system 100 according to the first embodiment, for example, rather than procuring the slice from the catalog at the start of the service, the service is accommodated once in the best-effort default slice 20, and the collector 80 measures the usage condition in the default slice 20 in sub-slice units. Then, only the sub-slice that has failed to meet the service requirements is switched to an automatically-generated new sub-slice. Thus, in the communication system 100 can reduce costs due to an improvement in the resource usage efficiency for the slice.

System Configuration and the Like

Each element of each apparatus illustrated is a functional concept and does not necessarily need to be physically configured as illustrated. That is, the specific form of distribution and integration of the apparatus is not limited to the illustrated form, and the entirety or a portion of the form can be configured by being functionally or physically dispatched and integrated in any unit, depending on various loads, usage conditions, and the like. Further, all or any part of each processing function to be performed in each apparatus can be realized by the CPU and a program analyzed and executed by the CPU, or can be realized as hardware by wired logic.

In addition, among processing described in the present embodiment, all or some of processes described as being performed automatically can be manually performed, or all or some of processes described as being performed manually can be performed automatically by well-known methods. In addition, information including the processing procedures, the control procedures, the specific names, and various data and parameters described in the above-described document and drawings can be arbitrarily changed except for the case of special description.

Program

A program in which the processing executed by each apparatus described in the aforementioned embodiment is described in a computer-executable language can also be created. For example, a program in which the processing executed by each apparatus in the communication system according to the aforementioned embodiment is described in a computer-executable language can also be created. In this case, the computer executes the program to obtain the same effects as the above-described embodiment. Hereinafter, one example of a computer that executes the program implementing will be described.

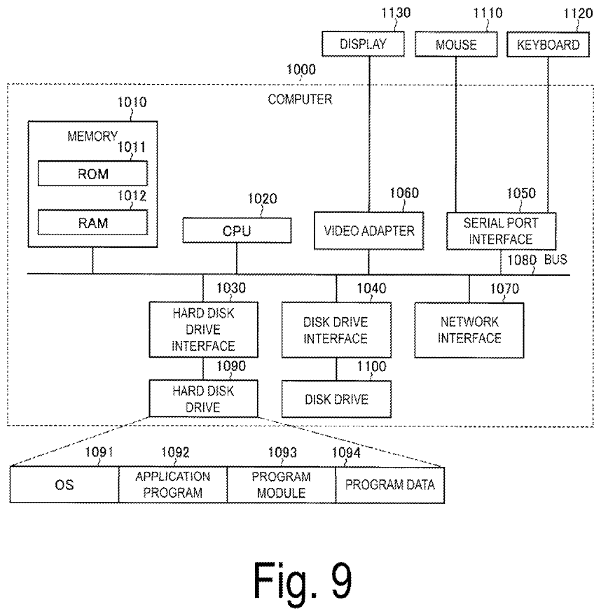

FIG. 9 is a view illustrating a computer that executes a program. A computer 1000 includes, for example, a memory 1010 and a CPU 1020. In addition, the computer 1000 includes a hard disk drive interface 1030, a disk drive interface 1040, a serial port interface 1050, a video adapter 1060, and a network interface 1070. These units are connected by a bus 1080.

The memory 1010 includes a read only memory (ROM) 1011 and a RAM 1012. The ROM 1011 stores a boot program, such as Basic Input Output System (BIOS), for example. The hard disk drive interface 1030 is connected to a hard disk drive 1090. The disk drive interface 1040 is connected to a disk drive 1100. A detachable storage medium such as a magnetic disk or an optical disc is inserted into the disk drive 1100. The serial port interface 1050 is connected to, for example, a mouse 1051 and a keyboard 1052. A video adapter 1060 is connected to, for example, a display 1061.

Here, the hard disk drive 1090 stores, for example, an OS 1091, an application program 1092, a program module 1093, and program data 1094. That is, a program defining each processing of each device is implemented as the program module 1093 in which computer-executable code has been described. The program module 1093 is stored in, for example, the hard disk drive 1090. For example, the program module 1093 for executing processing similar to the functional configuration of the apparatus is stored in hard disk drive 1090. Note that the hard disk drive 1090 may be replaced with a solid state drive (SSD).

In addition, data used in the processing of the above-described embodiment is stored in, for example, the memory 1010 or the hard disk drive 1090, as the program data 1094. In addition, the CPU 1020 reads the program module 1093 and the program data 1094 stored in the memory 1010 and the hard disk drive 1090 to the RAM 1012 and executes them as necessary.

Note that the program module 1093 and the program data 1094 are not limited to being stored in the hard disk drive 1090, and may be stored, for example, in a removable storage medium, and read by the CPU 1020 via a disk drive 1100 or its equivalent. Alternatively, the program module 1093 and the program data 1094 may be stored in another computer connected through a network or WAN. In addition, the program module 1093 and the program data 1094 may be read by the CPU 1020 from another computer through the network interface 1070.

### REFERENCE SIGNS LIST

10 OSS/BSS
20 Default slice
21, 31 SLG management unit
22, 32 SLG
30 New slice
40 Dispatching unit
51 Virtualization layer
52 Physical resource
60 NFV MANO
61 NFVO
61a Generation unit
62 VNFM
63 VIM
70 Telemetry orchestrator
80 Collector
81 Measurement unit
82 Calculation unit
100 Communication system

1. A communication system comprising:
an identifier configured to identify a usage condition in a service accommodated in a pre-generated default slice; and
a dispatcher configured to dispatch the service accommodated in the default slice to be accommodated in another slice separate from the default slice according to the usage condition identified by the identifier.

2. The communication system according to claim 1, wherein
the identifier is further configured to identify the usage condition in sub-slice units in the default slice, and
the dispatcher is further configured to switch a sub-slice determined to be unable to meet predetermined service requirements based on the usage condition identified by the identifier, to another sub-slice.

3. The communication system according to claim 1, further comprising:
a generator configured to generate a new slice based on the usage condition identified by the identifier, wherein
the dispatcher is further configured to dispatch the service accommodated in the default slice to be accommodated in the new slice generated by the generator.

4. The communication system according to claim 3, further comprising:
a determiner configured to determine a resource amount required for a service accommodated in the default slice based on the usage condition identified by the identifier, wherein
the generator unit is further configured to generate the new slice based on the required resource amount determined by the determiner.

5. A communication method performed by a communication system, the method comprising:
identifying, by an identifier a usage condition in a service accommodated in a pre-generated default slice; and
dispatching, by a dispatcher the service accommodated in the default slice to be accommodated in another slice separate from the default slice according to the usage condition identified through the identifying.

6. The communication method according to claim 5, the method further comprising:
identifying the usage condition in sub-slice units in the default slice, and
switching a sub-slice determined to be unable to meet predetermined service requirements based on the usage condition identified by the identifier, to another sub-slice.

7. The communication method according to claim 5, the method further comprising:
generating, by a generator, a new slice based on the usage condition identified by the identifier; and
dispatching, by the dispatcher, the service accommodated in the default slice to be accommodated in the new slice generated by the generator.

8. The communication method according to claim 7, the method further comprising:
determining a resource amount required for a service accommodated in the default slice based on the usage condition identified by the identifier; and
generating the new slice based on the required resource amount determined by the determiner.

9. A computer-readable non-transitory recording medium storing computer-executable instructions that when executed by a processor cause a computer system to:
identify, by an identifier a usage condition in a service accommodated in a pre-generated default slice; and
dispatch, by a dispatcher the service accommodated in the default slice to be accommodated in another slice separate from the default slice according to the usage condition identified through the identifying.

10. The computer-readable non-transitory recording medium according to claim 9, the computer-executable instructions when executed further causing the system to:
identify the usage condition in sub-slice units in the default slice, and
switch a sub-slice determined to be unable to meet predetermined service requirements based on the usage condition identified by the identifier, to another sub-slice.

11. The computer-readable non-transitory recording medium according to claim 9, the computer-executable instructions when executed further causing the system to:
generate, by a generator, a new slice based on the usage condition identified by the identifier; and
dispatch, by the dispatcher, the service accommodated in the default slice to be accommodated in the new slice generated by the generator.

12. The computer-readable non-transitory recording medium according to claim 11, the computer-executable instructions when executed further causing the system to:
determine a resource amount required for a service accommodated in the default slice based on the usage condition identified by the identifier; and
generate the new slice based on the required resource amount determined by the determiner.

13. The communication system according to claim 1, wherein a slice corresponds to a virtual network, wherein a sub-slice corresponds to a virtual sub-network, wherein the virtual network includes one or more virtual sub-networks, and wherein the slice and the sub-slice sharing at least a common physical resource in a network infrastructure.

14. The communication system according to claim 1, wherein a usage condition includes one or more of:
a traffic amount,
a central processing unit (CPU) utilization, and
a delay time.

15. The communication system according to claim 2, wherein the dispatcher is further configured to specify the switched sub-slice for another service.

16. The communication method according to claim 5, wherein a slice corresponds to a virtual network, wherein a sub-slice corresponds to a virtual sub-network, wherein the virtual network includes one or more virtual sub-networks, and wherein the slice and the sub-slice sharing at least a common physical resource in a network infrastructure.

17. The communication method according to claim 5, wherein a usage condition includes one or more of:
a traffic amount,
a central processing unit (CPU) utilization, and
a delay time.

18. The communication method according to claim 6, wherein the dispatcher is further configured to specify the switched sub-slice for another service.

19. The computer-readable non-transitory recording medium according to claim 9, wherein a slice corresponds to a virtual network, wherein a sub-slice corresponds to a virtual sub-network, wherein the virtual network includes one or more virtual sub-networks, and wherein the slice and the sub-slice sharing at least a common physical resource in a network infrastructure.

20. The computer-readable non-transitory recording medium according to claim 10, wherein a usage condition includes one or more of:
a traffic amount,
a central processing unit (CPU) utilization, and
a delay time, and
wherein the dispatcher is further configured to dispatch the switched sub-slice for use in another service.
